(19) United States
(12) Patent Application Publication
(10) Pub. No.: US 2024/0146605 A1
(43) Pub. Date: May 2, 2024

(54) METHOD FOR CONTROLLING A SLAVE CLUSTER OF NODES BY A MASTER CLUSTER OF NODES, CORRESPONDING DEVICES AND COMPUTER PROGRAMS

(71) Applicant: Orange, Issy-Les-Moulineaux (FR)

(72) Inventors: Romuald CORBEL, Chatillon Cedex (FR); Emile STEPHAN, Chatillon Cedex (FR); Gaël FROMENTOUX, Chatillon Cedex (FR)

(21) Appl. No.: 18/547,860

(22) PCT Filed: Feb. 16, 2022
(86) PCT No.: PCT/FR2022/050279

§ 371 Date: Aug. 24, 2023

(30) Foreign Application Priority Data
Feb. 25, 2021 (FR) 2101850

(51) Int. Cl. H04L 41/0806; G06F 9/48

(52) U.S. Cl. CPC H04L 41/0806; G06F 9/4843

(57) ABSTRACT

A solution for orchestrating a plurality of clusters of nodes that have to identically execute identical tasks while being not co-located. It is difficult to deploy an architecture where clusters of nodes are distributed both on the ground and in one or more satellite(s). The solution enables such a deployment by establishing a master-slave relationship between a first and a second cluster of nodes. It is then possible to overcome problems related to the synchronization of the databases of the clusters of nodes since only the synchronization of the database of the master cluster of nodes matters. Once the slave clusters of nodes have been configured, the databases of the slave clusters of nodes do not need to be synchronized with the database of the management node of the master cluster of nodes.

### CROSS-REFERENCE TO RELATED APPLICATIONS

This application is filed under 35 U.S.C. § 371 as the U.S. National Phase of Application No. PCT/FR2022/050279 entitled “METHOD FOR CONTROLLING A SLAVE CLUSTER OF NODES BY A MASTER CLUSTER OF NODES, CORRESPONDING DEVICES AND COMPUTER PROGRAMS” and filed Feb. 16, 2022, and which claims priority to FR 2101850 filed Feb. 25, 2021, each of which is incorporated by reference in its entirety.

### BACKGROUND

### Field

The field of the development is that of cloud computing.

More specifically, the development relates to a solution enabling the orchestration of a plurality of clusters of nodes having to execute identical tasks in an identical manner although these different clusters of nodes are not co-located.

### Prior Art and Its Drawbacks

For several years, telecommunications networks have been using virtualized functions hosted in servers, or nodes, grouped together into clusters, giving rise to cloud computing.

A solution for orchestrating these clusters of nodes is known as the Kubernetes solution. FIG. 1 shows in a simplified manner the architecture of a cluster of nodes 1 in accordance with the Kubernetes solution. The cluster of nodes 1 comprises a first node 10 called the management node, or “Kubernetes master”, and N computing nodes, or “Kubernetes node” , 11ᵢ, iϵ{1, . . . , N), N being an integer.

The management node 10 comprises a controller 101, an API (Application Programming Interface) module 102 and a so-called ETCD database 103 which consists of a dynamic register for configuring the computing nodes 11ᵢ.

A computing node 11ᵢ comprises M containers or “pods” 110ⱼ, jϵ{1, . . . , M), M being an integer. Each container 110ⱼ is provided with resources enabling the execution of one or more task(s). When executed, a task contributes to the implementation of a service or a network function, such as a DHCP (Dynamic Host Configuration Protocol) function for example.

In order to reduce costs and improve the flexibility of network infrastructures, cloud computing architectures are most often multi-site architectures in which the constituent nodes of clusters of nodes may be not co-located. For example, a management node 10 and two computing nodes 11₁, 11₂ of a cluster of nodes 1 are located on a site A while three other computing nodes 11₃, 11₄, 11₅ are located on a remote site B.

In such a case, it is necessary to synchronize the operating states of the different tasks executed by the computing nodes 11ᵢ of the same cluster of nodes 1 to ensure the proper provision of the required service or the proper execution of the network function.

This is particularly important in the case where a portion of a cluster of nodes 1 is deployed both in ground sites and in satellites in orbit around the Earth. Indeed, all of the deployed containers 110ⱼ of the cluster of nodes 1 should be supervised and orchestrated permanently.

Yet, it is difficult to deploy a unique management node 10 distributed both in the terrestrial portion and in the satellite portion of the cluster of nodes 1 because such a too much latency does not allow for a satisfactory level of synchronization between the portion of the database 103 located on the ground and the portion of the database 103 located in the satellite.

It is also difficult to orchestrate the containers 110ⱼ embedded in a satellite via a management node 10 located on the ground because the satellite is not permanently within the range of the management node 10.

In order to solve this problem, a first solution consists in deploying a first cluster of nodes on the ground and a second cluster of nodes in one or more satellite(s) in orbit. The satellites being in continuous movement around the Earth, the cluster of nodes embedded in the satellites modifies its configuration in order to adapt to all of the needs and constraints formulated by the different operators managing the telecommunication networks of the different countries it flies over. These reconfiguration operations, like the deployment of another operating system, the setup of dependencies, the deployment and then the update of the management and computing nodes, are time-consuming. Indeed, it takes about ten minutes for a complete deployment of this type, which occupies a very large portion of the coverage period of a country by the satellite.

A second solution consists in deploying several management nodes 10 for the same cluster of nodes 1 on the ground and in one or more satellite(s). However, such an architecture induces a latency time for the synchronization of the databases 103 embedded in each of the management nodes 10. Indeed, these databases 103 operate together by means of a consensus algorithm, called RAFT. This algorithm is based on the use of timeouts which are sensitive to the latency introduced between each operation of replicating the content of a database 103. Yet, the databases 103 are updated quite often in order to keep the operating status of a cluster of nodes 1 up-to-date.

Thus, the distribution of the management nodes 10 between the ground and the satellites results in a lengthening of the responsiveness of the management nodes of the cluster of nodes 1 which introduces service interruptions.

Hence, there is a need for a solution for deploying clusters of nodes that does not have all or part of the aforementioned drawbacks.

### SUMMARY

The development addresses this need by providing a method for controlling a first cluster of nodes, called slave cluster, by a second cluster of nodes, called master cluster, a cluster of nodes comprising at least one computing node executing at least one task, said control method being implemented by said master cluster and comprising the following steps of:
receiving a request for taking control of said slave cluster identifying at least one task intended to be executed by at least one computing node of said slave cluster,
creating a configuration file of said slave cluster comprising takeover parameters and expected execution conditions of said task by said at least one computing node of said slave cluster, said expected execution conditions of said task being identical to the current execution conditions of said task by at least one computing node of said master cluster,
transmitting said configuration file to said slave cluster,
receiving a message comprising information relating to the implementation, by the slave cluster, of the required configuration.

Such a solution allows deploying a cloud computing solution wherein the clusters of nodes forming the deployed architecture are not co-located but do not have the aforementioned drawbacks of the prior art.

This is made possible by establishing a master-slave relationship between a first cluster of nodes and a second cluster of nodes.

Such a solution allows overcoming the problems related to the synchronization of the databases of the management nodes of the clusters of nodes since in such a solution, only the synchronization of the database of the management node of the master cluster of nodes matters. Indeed, in the present solution, once the slave cluster of nodes has been configured by means of the configuration file, the databases of the management nodes of the clusters of slave nodes do not need to be synchronized with the database of the management node of the master cluster of nodes. This is possible because the execution conditions specified in the configuration file correspond to the current execution conditions applied by the nodes of the master cluster.

Thus, although from a hardware perspective, the two clusters of nodes, master and slave, are independent clusters of nodes, they, from a functional perspective, behave like one single same cluster of nodes. The master cluster and the slave cluster are related to one another and have an identical behavior enabling a proper execution of the required services or network functions.

The execution conditions of the tasks by the master cluster and the slave cluster are identical because these two clusters belonging to the same cloud computing architecture, it is essential to ensure a coherent execution of the network functions between the different components of the cloud computing architecture knowing that, for a given service or a given network function, some tasks related to the provision of this service or this function will be executed in par in the master cluster and in par in the slave cluster.

Thus, an execution condition may be a minimum memory capacity required for the execution of the task. As long as the execution condition is met by the master cluster and the slave cluster, the effective memory capacity of the master cluster and of the slave cluster may be different. Thus, if the execution condition is minimum memory capacity required=2 GB of memory and the master cluster features a memory capacity of 6 GB and the slave cluster features a memory capacity of 4 GB, then the execution condition is met since both master and slave clusters identically meet an identical execution condition, namely featuring a minimum memory capacity of 2 GB.

In the solution object of the development, all it needs is to configure a first cluster of nodes, located for example on the ground, and ask it to take control of a second cluster of nodes, for example located in one or more satellite(s), or in any other vehicle of a fleet. When the first cluster could communicate with the second cluster, it takes control thereof and transfers a configuration file thereto enabling the second cluster to execute the required tasks.

According to a first implementation of the method for controlling a slave cluster of nodes, the tasks executed by the master cluster being distributed into a plurality of groups of tasks, a group of tasks comprising at least one task, the configuration file comprises an identifier of at least one group of tasks and the expected execution conditions relating to said group of tasks.

It is interesting to divide the different tasks to be carried out into groups. For example, such groups may comprise all of the tasks to be executed to deliver a service or execute a network function. Other groups may comprise tasks of the same kind, the tasks may also be grouped according to the types of resources they require for execution thereof.

Afterwards, each group is provided with an identifier and one or more set(s) of execution conditions.

Thus, only some groups of tasks could be executed by the computing nodes of the slave cluster whereas others are executed only by the computing nodes of the master cluster. The same group of tasks could be executed by both the computing nodes of the master cluster and the computing nodes of the slave cluster.

In a particular embodiment of the control method, the latter further comprises the following steps of:
receiving a request for modifying the configuration of said master cluster comprising expected execution conditions of said task by said at least one computing node of said master cluster,
configuring said master cluster by means of said expected execution conditions, said expected execution conditions becoming, upon completion of said configuration step, the new current execution conditions of said task,
creating an update file of the configuration of said slave cluster comprising the expected execution conditions of said task by said at least one computing node of said slave cluster, said expected execution conditions of said task being identical to the new current execution conditions of said task by at least one computing node of said master cluster,
transmitting said configuration update file to said slave cluster.

Thus, each update of the configuration of the master cluster is dynamically deployed on the slave cluster thereby ensuring that the master cluster and the slave cluster always have an identical behavior.

When the update of the configuration of the slave cluster fails, the method further comprises a step of receiving a message indicating the failure of the update of the configuration by the slave cluster.

Thus, the master cluster could seek to take control of another slave cluster in order to be able to provide the required services or network functions.

When the update of the configuration of the slave cluster fails, the control method further comprises, in a particular implementation, a step of receiving a message comprising information relating to the implementation, by the slave cluster, of the update of the configuration of at least one other slave cluster to which the slave cluster has transmitted a configuration file comprising expected execution conditions of said task by said at least one computing node of said other slave cluster, said expected execution conditions of said task being identical to the current execution conditions of said task by at least one computing node of said master cluster.

In this particular implementation, the first slave cluster being unable to implement the configuration requested by the master cluster, it takes control of a second slave cluster. For this purpose, the slave cluster behaves like the master cluster by transmitting a configuration file comprising a takeover request to the second slave cluster.

The master cluster is informed about this situation.

When the master and slave clusters cannot communicate directly, an intermediate piece of equipment serves as a relay. In such a case, the method comprises a step of receiving a message emitted by the intermediate piece of equipment indicating the impossibility of transmitting a configuration file to said slave cluster.

Thus, the master cluster could seek to take control of another slave cluster in order to be able to provide the required services or network functions via the intermediate piece of equipment or not.

In another implementation of the control method, the latter comprises:
a step for receiving an error message emitted by the slave cluster,
a step of creating a repair file of said slave cluster comprising repair parameters of said slave cluster,
transmitting said repair file to said slave cluster.

When the master cluster is informed about the occurrence of an error at the slave cluster, it tries to proceed with a repair in order to ensure continuity of service.

Finally, in some embodiments, the control method may also comprise:
a step of receiving a liberation request from said slave cluster,
a step of creating a configuration file of said slave cluster comprising liberation parameters of said slave cluster,
a step of transmitting said configuration file to said slave cluster.

Thus, when circumstances so require, the slave cluster gets back its independence and could be used in a standalone manner, i.e. without a master, or under the control of a new master, etc.

Another object of the development is a method for configuring a first cluster of nodes, called slave cluster, by a second cluster of nodes, called master cluster, a cluster of nodes comprising at least one computing node executing at least one task, said configuration method being implemented by said slave cluster and comprising the following steps of:
receiving a configuration file of said slave cluster comprising takeover parameters and expected execution conditions of said task by said at least one computing node of said slave cluster, said expected execution conditions of said task being identical to current execution conditions of said task by at least one computing node of said master cluster,
verifying an availability of the resources required for the execution of said task,
when the required resources are available, configuring said slave cluster by means of said configuration file,
transmitting, to the master cluster, a message comprising information relating to the implementation, by the slave cluster, of the required configuration.

If it is unable to provide the resources required by the master cluster, the slave cluster informs the latter which could then seek to take control of a new slave cluster.

According to a particular implementation, the configuration method further comprises the following steps of:
receiving an update file of the configuration of said slave cluster comprising expected execution conditions of said task by said at least one computing node of said slave cluster, said expected execution conditions of said task being identical to new current execution conditions of said task by at least one computing node of said master cluster,
verifying an availability of the resources required for the execution of said task,
when the required resources are available, updating the configuration of said slave cluster by means of said configuration update file,
transmitting, to the master cluster, a message comprising information relating to the implementation, by the slave cluster, of the required configuration.

Thus, when the required resources are available, the configuration of the slave cluster is dynamically updated and always operates identically to the master cluster.

When the required resources are not available, the configuration method further comprises a step of emitting a message indicating the failure of the update of the configuration to the master cluster.

Thus, the master cluster could seek to take control of another slave cluster in order to be able to provide the required services or network functions.

The configuration method further comprises when the required resources are not available:
a step of transmitting a configuration file comprising expected execution conditions of said task by at least one computing node of another slave cluster, said expected execution conditions of said task being identical to the current execution conditions of said task by at least one computing node of said master cluster,
a step of receiving a message comprising information relating to the implementation, by said other slave cluster, of the required configuration,
a step of transmitting, to the master cluster, a message comprising information relating to the implementation, by said other slave cluster, of the required configuration.

In this particular implementation, the first slave cluster being unable to implement the configuration requested by the master cluster, it takes control of a second slave cluster. For this purpose, the slave cluster behaves like the master cluster by transmitting a configuration file comprising a takeover request to the second slave cluster.

The master cluster is informed about this situation.

Another object of the development is a management node of a first cluster of nodes, called master cluster, capable of controlling a second cluster of nodes, called slave cluster, a cluster of nodes also comprising at least one computing node executing at least one task, said management node of the master cluster comprising means for:
receiving a request for taking control of said slave cluster identifying at least one task intended to be executed by at least one computing node of said slave cluster,
creating a configuration file of said slave cluster comprising takeover parameters and expected execution conditions of said task by said at least one computing node of said slave cluster, said expected execution conditions of said task being identical to the current execution conditions of said task by at least one computing node of said master cluster,
transmitting the configuration file to said slave cluster,
receiving a message comprising information relating to the implementation, by the slave cluster, of the required configuration.

The development also relates to a management node of a first cluster of nodes, called slave cluster, capable of configuring said slave cluster, a cluster of nodes also comprising at least one computing node executing at least one task, said slave cluster management node comprising means for:
receiving, from a second cluster of nodes, called master cluster, a configuration file of said slave cluster comprising takeover parameters and expected execution conditions of said task by said at least one computing node of said slave cluster, said expected execution conditions of said task being identical to current execution conditions of said task by at least one computing node of said master cluster,
verifying an availability of the resources required for the execution of said task,
when the required resources are available, configuring said slave cluster by means of said configuration file,
transmitting, to the master cluster, a message comprising information relating to the implementation, by the slave cluster, of the required configuration.

Finally, other objects of the development are computer program products comprising program code instructions for the implementation of the methods as described before, when these are executed by a processor.

The development also relates to a computer-readable recording medium on which computer programs are recorded comprising program code instructions for the execution of the steps of the methods according to the development as described hereinabove.

Such a recording medium may consist of any entity or device capable of storing the programs. For example, the medium may include a storage means, such as a ROM, for example a CD ROM or a microelectronic circuit ROM, or else a magnetic recording means, for example a USB flash disk or a hard disk.

On the other hand, such a recording medium may be a transmissible medium such as an electrical or optical signal, which can be conveyed via an electrical or optical cable, by radio or by other means, so that the computer programs it contains can be executed remotely. In particular, the programs according to the development may be downloaded on a network, for example the Internet network.

Alternatively, the recording medium may be an integrated circuit in which the programs are incorporated, the circuit being adapted to execute or to be used in the execution of the aforementioned methods object of the development.

### BRIEF DESCRIPTION OF THE DRAWINGS

Other aims, features and advantages of the development will appear more clearly upon reading the following description, given merely as an illustrative and non-limiting example with reference to the figures, wherein:

FIG. 1 shows in a simplified manner the architecture of a cluster of nodes in accordance with the prior art,

FIG. 2 shows in a simplified manner the architecture of a cluster of nodes in accordance with the solution object of the present development,

FIG. 3 shows the steps of the control and configuration methods when these are implemented by the different constituents of a master cluster and a slave cluster,

FIG. 4 shows the steps of an orchestration loop of a cluster of nodes,

FIG. 5 shows the steps of the control and configuration methods when these are implemented by the different constituents of a master cluster and of a first slave cluster in the case where, the first slave cluster being already controlled by the master cluster, the configuration of the master cluster is updated,

FIG. 6 shows the steps of the control and configuration methods when these are implemented by the different constituents of a master cluster and of a first slave cluster in the case where, the first slave cluster being already controlled by the master cluster, the slave cluster detects an error,

FIG. 7 shows the steps of the control and configuration methods when these are implemented by the different constituents of a master cluster and of a first slave cluster in the case where the messages exchanged between the master cluster and the first slave cluster are relayed by an intermediate piece of equipment,

FIG. 8 shows a management node able to implement the different methods object of the present development.

### DETAILED DESCRIPTION OF CERTAIN ILLUSTRATIVE EMBODIMENTS

The general principle of the development is based on the establishment of a master-slave relationship between two clusters of nodes which may be co-located, or not. The establishment of this master-slave relationship allows, in particular when a first cluster of nodes is located on the ground and a second cluster of nodes is located in a satellite in orbit around the Earth, overcoming the problems of synchronization of the databases present in the management nodes of the clusters of nodes with each other while ensuring that the two clusters of nodes have identical behavior thereby enabling the proper provision of a required service or a required network function.

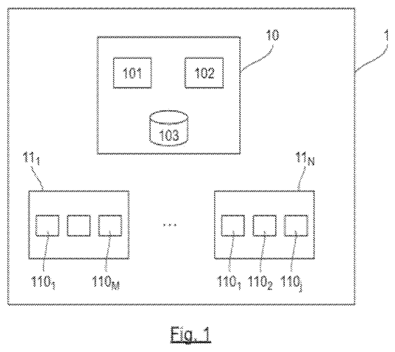

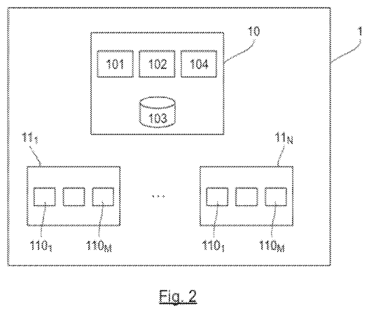

FIG. 2 shows in a simplified manner the architecture of a cluster of nodes 1 in accordance with the solution object of the present development. The elements already described with reference to FIG. 1 keep the same reference signs.

The cluster of nodes 1 comprises a first node 10 called the management node, or “Kubernetes master”, and N computing nodes, or “Kubernetes node”, 11ᵢ, iϵ{1, . . . , N), N being an integer.

The management node 10 comprises a controller 101, an API (Application Programming Interface) module 102, a so-called ETCD database 103 which consists of a dynamic register for configuring the computing nodes 11, and at least one synchronization module 104. Such a synchronization module 104 may be a master synchronization module 104M or a slave synchronization module 104E depending on whether the management node 10 in which it is located belongs to a master cluster of nodes or a slave cluster of nodes. The same management node 10 may comprise both a master synchronization module 104M and a slave synchronization module 104E because the cluster of nodes to which it belongs may be both the slave of a first cluster of nodes and the master of a second cluster of nodes as will be detailed later on.

A computing node 11, comprises M containers or “pods” 110ⱼ, jϵ{1, . . . , M), M being an integer. Each container 110ⱼ is provided with resources enabling the execution of one or more task(s). When executed, a task contributes to the implementation of a service or a network function, such as a DHCP (Dynamic Host Configuration Protocol) function for example.

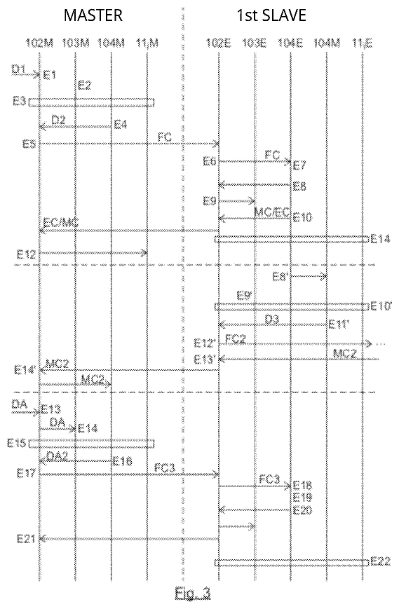

FIG. 3 shows the steps of the control and configuration methods when these are implemented by the different constituents of a master cluster and of a slave cluster.

In a step E1, the module API 102M of the management node 10M of the master cluster receives a takeover request D1 from a first slave cluster. Such a request comprises an identifier IdT of at least one task intended to be executed by at least one computing node 11ᵢE of the first slave cluster. The takeover request may be emitted by a piece of equipment of a telecommunications network managed by the same telecommunications operator managing the master cluster.

An example of such a takeover request D1 is as follows:

apiVersion: apps/vx
kind: CreateEsclave
spec:
esclave:
- name: IDESCLAVE
ipEsclave: x.x.x.x
deploymentEsclave: IFNOTEXISTCREATE
apiVersion: apps/vx
kind: DeploymentEsclave
metadata:
name: NameDeployement
labels:
app: LabelDeployement
spec:
replicas: NombreDeReplicat
selector:
matchLabels:
app: LabelDeployement
template:
metadata:
labels:
app: LabelDeployement
spec:
esclave: IDESCLAVE/IPESCLAVE
containers:
- name: NOMAPPLICATION
image: NONCONTENEUR
ports:
- containerPort: port
resources:
limits:
RESSOURCELIMITE
requests:
RESSOURCEDEMANDE

In a step E2, this takeover request D1 is transmitted to the database 103M which updates its registers with the information comprised in the takeover request D1 such as, inter alia, an identifier IdT of at least one task to be executed by at least one computing module 11ᵢE of the first slave cluster, an identifier of the first slave cluster and information relating to the execution conditions of the task by the computing node 11ᵢE.

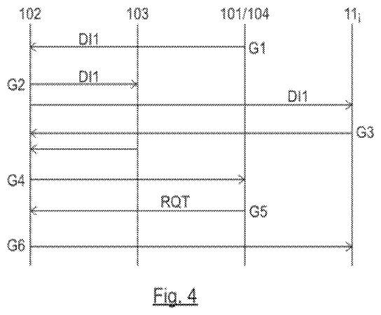

During a step E3, an orchestration loop is implemented by the master cluster. Such an orchestration loop is described with reference to FIG. 4,

An orchestration loop is a process implemented in a cluster of nodes during which the execution conditions of the tasks executed by the computing nodes 11ᵢ are updated according to: information comprised in the database 103 and information on the current execution conditions of the tasks by the computing nodes 11ᵢ.

The information on the current execution conditions of the tasks is fed back by the computing nodes 11ᵢ to the controller 101 or to the module API 102. The update of the content of the database 103 is independent of the execution of an orchestration loop.

The takeover request D1 being able to indicate which tasks executed by the computing nodes 11ᵢ of the master cluster of nodes are intended to be executed by the computing nodes 11ᵢ of the first slave cluster of nodes, the implementation of such an orchestration loop allows updating the operation of the master cluster of nodes.

Thus, the execution of an orchestration loop allows switching from a so-called current operating state of a cluster of nodes, the current state being defined in particular by the current execution conditions of the tasks by the computing nodes 11ᵢ and the current content of the registers of the database 103, into a so-called expected state operating state which is defined, inter alia, by the execution conditions of the tasks specified in the takeover request D1. Upon completion of the execution of the orchestration loop, the expected state of the cluster of nodes becomes the new current state.

Although described as implemented within a management node 10M belonging to a master cluster, such an orchestration loop is implemented identically within a management node 10E belonging to a first slave cluster.

Thus, in a step G1, the controller 101 or the synchronization module 104 transmits a first request for information DI1 to the module API 102.

In a step G2, the module API 102 transmits the information request DI1 to the database 103 and to at least one computing node 11ᵢ.

During a step G3, the database 103 and the computing node 11ᵢ transmit the required information to the module API 102. The module API 102 then transmits this information to the controller 101 or to the synchronization module 104 during a step G4.

In a step G5, the controller 101 or the synchronization module 104 transmits a request RQT in application of a configuration determined by means of the information received during the step G4.

Once the orchestration loop has been implemented, the master synchronization module 104M creates a configuration file FC and transmits the latter to the module API 102M in a step E4.

The module API 102M then transmits, in a step E5, the configuration file FC of the first slave cluster comprising takeover parameters and expected execution conditions of said task by the computing node 11ᵢE, the expected execution conditions of the task being identical to the current execution conditions of the same task by the computing node 11ᵢM. The execution conditions comprised in the configuration file may consist of constraints for the task to be correctly executed such as the hardware resources like the required CPU, GPU, radio antennas, but also the maximum resources authorized for a given task: maximum number of CPUs, required minimum read-access memory resources, etc.

The tasks executed by the master cluster may be distributed into a plurality of task groups, a task group comprising at least one task. In such a situation, the Configuration file FC comprises an identifier of at least one group of tasks and the expected execution conditions related to said group of tasks.

For example, such groups may comprise all of the tasks to be executed to deliver a service or execute a network function. Other groups may comprise tasks of the same kind, the tasks may also be grouped according to the type of resources they require for the execution thereof.

Afterwards, each group is provided with an identifier and one or more set(s) of execution conditions.

Only some groups of tasks may be executed by the computing nodes of the first slave cluster whereas others are executed only by the computing nodes of the master cluster. The same group of tasks may be executed by both the computing nodes of the master cluster and the computing nodes of the first slave cluster.

The module API 102E of the management node 10E of the first slave cluster receives the configuration file FC during a step E6 and transmits it to the slave synchronization module 104E.

During a step E7, the slave synchronization module 104E verifies, before at least one computing node 11ᵢE, the availability of the resources required for the execution of the task identified in the configuration file FC. The slave synchronization module 104E transmits the result of this verification to the module API 102E in a step E8. In turn, the module API 102E transmits this information to the database 103E which updates its registers in a step E9.

If, in a first case, the slave synchronization module 104E has determined that the required resources are available, it transmits a message MC, called confirmation message, comprising information relating to the implementation, by the slave cluster, of the required configuration and therefore indicating the takeover of the first slave cluster by the master cluster to the module API 102E which, in turn, transmits it to the module API 102M of the management node 10M of the master cluster during a step E10. Steps E8 and E10 may be executed simultaneously.

Concomitantly with the execution of step E10, the first slave cluster implements, in a step E11, an orchestration loop as described with reference to FIG. 4 in order to configure all of the computing nodes 11ᵢE of the first slave cluster with the execution conditions comprised in the configuration file emitted by the master cluster.

Upon completion of this step E11, the first slave cluster is controlled by the master cluster and has an operation identical to that of the master cluster. In other words, upon completion of step E11, the tasks executed by the computing nodes 11ᵢE of the first slave cluster are executed in the same manner, under the same conditions and with the same constraints as when they are executed by the computing nodes 11ᵢM of the master cluster.

Finally, in a step E12, the module API 102M of the management node 10M of the master cluster transmits the confirmation message MC to the master synchronization module 104M.

Once the takeover of first slave cluster has performed, the first slave cluster recurrently transmits to the module API 102 of the master cluster data relating to the execution of the tasks executed by its computing nodes 11ᵢE.

If, in a second case, during step E7, the slave synchronization module 104E has determined that the required resources are not available, the slave synchronization module 104E transmits the result of this verification to the module API 102E in step E8. In turn, the module API 102E transmits this information to the database 103E which updates its registers in step E9.

When the slave synchronization module 104E has determined that the required resources are not available, it then transmits a message of failure EC of the takeover of the first slave cluster by the master cluster to the module API 102E which, in turn, transmits it to the module API 102M of the management node 10M of the master cluster during step E10.

In a second embodiment, when during step E7, the slave synchronization module 104E has determined that the required resources are not available, the slave synchronization module 104E transmits the result of this verification to the database 103E in step E8′ .

This second embodiment can be implemented only if the master cluster explicitly authorizes the takeover of a second slave cluster by the first slave cluster. Such an authorization is comprised in the configuration file FC transmitted during step E5.

In a step E9′, the database 103E updates its registers with the results of the verification.

During a step E10′, an orchestration loop is implemented by the first slave cluster in order to instantiate a master synchronization module 104M in the management node 10E of the first slave cluster

Once the orchestration loop has been implemented, the master synchronization module 104M of the management node 10E of the first slave cluster is instantiated and transmits a request D3 for taking control of a second slave cluster to the module API 102E in a step E11′. The takeover request D3 comprises a configuration file FC2 of a second slave cluster created by the master synchronization module 104M.

In another implementation wherein the management node 10E of the first slave cluster already comprises a master synchronization module 104M, the master synchronization module 104M of the management node 10E transmits, directly after step E7, a request D3 for taking control of the second slave cluster to the module API 102E in a step E11′.

The module API 102E then transmits, in a step E12′, the configuration file FC2 of the second slave cluster comprising takeover parameters and expected execution conditions of said task by a computing node 11ᵢE of the second slave cluster, the expected execution conditions of the task being identical to the current execution conditions of the same task by the computing node 11ᵢM of the master cluster. The configuration file FC2 is created during the execution of step E11′.

A module API 102E of a management node 10E of the second slave cluster receives the configuration file FC2 and transmits it to a slave synchronization module 104E of the second slave cluster.

The slave synchronization module 104E of the second slave cluster verifies, before at least one computing node 11ᵢE of the second slave cluster, the availability of the resources required for the execution of the task identified in the configuration file FC2. The slave synchronization module 104E of the second slave cluster transmits the result of this verification to the module API 102E of the second slave cluster. In turn, the module API 102E of the second slave cluster transmits this information to the database 103E of the second slave cluster which updates its registers.

When the slave synchronization module 104E of the second slave cluster has determined that the required resources are available, it transmits a message MC2 confirming the takeover of the second slave cluster by the first slave cluster to the module API 102E of the second slave cluster which, in turn, transmits it to the module API 102E of the management node 10E of the first slave cluster during a step E13′.

At the same time, the second slave cluster implements an orchestration loop as described with reference to FIG. 4 in order to configure all of the computing nodes 11ᵢE of the second slave cluster with the execution conditions comprised in the configuration file FC2.

Upon completion of this step E13′, the second slave cluster is controlled by the first slave cluster, itself controlled by the master cluster, and has an operation identical to that of the master cluster.

Finally, in a step E14′, the module API 102E of the management node 10E of the first slave cluster transmits the confirmation message MC2 to the module API 102M of the management node 10M of the master cluster which, in turn, transmits it to the master synchronization module 104M.

Once the second slave cluster has been taken over, the first slave cluster recurrently transmits data relating to the execution of the tasks executed by the computing nodes 11ᵢE of the second slave cluster to the master cluster.

When circumstances so require, for example when the satellite carrying the first slave cluster no longer flies over the territory in which the master cluster is located, the first slave cluster may be liberated and thus get back its independence in order to be used in a standalone manner or under the control of a new master cluster.

In a step E13, the module API 102M of the master cluster receives a liberation request DA from the first slave cluster.

In a step E14, this liberation request DA is transmitted to the database 103M which updates its registers with the information comprised in the liberation request DA.

During a step E15, an orchestration loop is implemented by the master cluster.

Once the orchestration loop has been implemented, the master synchronization module 104M transmits a liberation request DA2 from the first slave cluster to the module API 102M in a step E16.

The module API 102M then transmits, in a step E17, a configuration file FC3 of the first slave cluster comprising liberation parameters of said first slave cluster.

The module API 102E of the management node 10E of the first slave cluster receives the configuration file FC3 during a step E18 and transmits it to the slave synchronization module 104E.

During a step E19, the slave synchronization module 104E processes the configuration file FC3 and transmits the processing result to the module API 102E in a step E20. In turn, the module API 102E transmits this information to the database 103E which updates its registers.

When the slave synchronization module 104E has processed the configuration file FC3, it transmits a liberation message from the first slave cluster to the master to the module API 102E which, in turn, transmits it to the module API 102M of the management node 10M of the master cluster during a step E21.

Concomitantly with the execution of step E21, the first slave cluster implements, in a step E22, an orchestration loop as described with reference to FIG. 4 in order to configure all of the computing nodes 11ᵢE of the first slave cluster.

Upon completion of this step E21, the first slave cluster is no longer controlled by the master cluster and operates in a standalone manner.

An identical procedure may be implemented between the first slave cluster and the second slave cluster in order to put an end to the control of the second slave cluster by the first slave cluster.

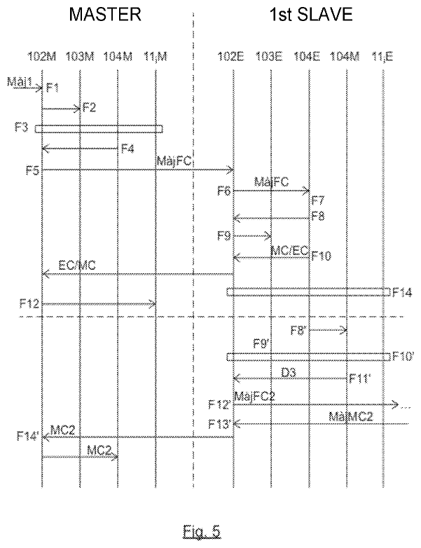

FIG. 5 shows the steps of the control and configuration methods when these are implemented by the different constituents of a master cluster and of a first slave cluster in the case where, the first slave cluster being already controlled by the master cluster, the configuration of the master cluster is updated. Typically, the sequence of steps described with reference to FIG. 5 is located between steps E12 and E13 described with reference to FIG. 3.

In a step F1, the module API 102M of the management node 10M of the master cluster receives a request MaJ1 for updating the configuration of the master cluster. Such an update request MaJ1 comprises an identifier IdT of at least one task intended to be executed by at least one computing node 11ᵢM of the master cluster. The update request MaJ1 may be emitted by a piece of equipment of a telecommunications network managed by the same telecommunications operator managing the master cluster. Such an update request MaJ1 is similar to a takeover request such as that one described with reference to FIG. 3.

An example of such a configuration update request is as follows:

apiVersion: apps/vx
kind: DeploymentEsclave
metadata:
name: NameDeployement
labels:
app: LabelDeployement
spec:
replicas: NombreDeReplicat
selector:
matchLabels:
app: LabelDeployement
template:
metadata:
labels:
app: LabelDeployement
spec:
esclave: IDESCLAVE/IPESCLAVE
containers:
- name: NOMAPPLICATION
image: NONCONTENEUR
ports:
- containerPort: port
resources:
limits:
RESSOURCELIMITE
requests:
RESSOURCEDEMANDE

In a step F2, this update request MaJ1 is transmitted to the database 103M which updates its registers with the information comprised in the update request MaJ1 such as, inter alia, an identifier IdT of at least one task to be executed by at least one computing module 11ᵢM of the master cluster and information relating to the execution conditions of the task by the computing node 11ᵢM.

During a step F3, an orchestration loop is implemented by the master cluster.

Once the orchestration loop has been implemented, the cluster master configuration is updated. Following this update of the master cluster configuration, the execution conditions of some tasks may have changed, new tasks may be executed and some tasks may be completed.

The master synchronization module 104M then creates and transmits a configuration update file MaJFC of the first slave cluster to the module API 102M in a step F4.

The module API 102M then transmits, in a step F5, the configuration update file MaJFC of the first slave cluster comprising expected execution conditions of said task by the computing node 11ᵢE, the expected execution conditions of the task being identical to the current execution conditions of the same task by the computing node 11ᵢM, i.e. the conditions under which the tasks are executed by the computing node 11ᵢM following the implementation of the orchestration loop at step F3.

The module API 102E of the management node 10E of the first slave cluster receives the configuration update file MaJFC during a step F6 and transmits it to the slave synchronization module 104E.

During a step F7, the slave synchronization module 104E verifies, for example with at least one computing node 11ᵢE, the availability of the resources required for the execution of the task identified in the configuration update file MaJFC. The slave synchronization module 104E transmits the result of this verification to the module API 102E in a step F8. In turn, the module API 102E transmits this information to the database 103E which updates its registers in a step F9.

If, in a first case, the slave synchronization module 104E has determined that the required resources are available, it transmits a message comprising information relating to the implementation of the required update, called the update confirmation message MC, from the first slave cluster to the module API 102E which, in turn, transmits it to the module API 102M of the management node 10M of the master cluster during a step F10.

Concomitantly with the execution of step F10, the first slave cluster implements, in a step F11, an orchestration loop as described with reference to FIG. 4 in order to configure all of the computing nodes 11ᵢE of the first slave cluster with the execution conditions comprised in the configuration update file emitted by the master cluster.

Upon completion of this step F11, the first slave cluster is updated and has an operation identical to that of the master cluster.

Finally, in a step F12, the module API 102M of the management node 10M of the master cluster transmits the update confirmation message MC to the master synchronization module 104M of the master cluster.

Once the update of the first slave cluster has been performed, the first slave cluster recurrently transmits data relating to the execution of the tasks executed by its computing nodes 11ᵢE.

If, in a second case, during step F7, the slave synchronization module 104E has determined that the required resources are not available, the slave synchronization module 104E transmits the result of this verification to the destination of the module API 102E in step F8. In turn, the module API 102E transmits this information to the database 103E which updates its registers in step F9.

When the slave synchronization module 104E has determined that the required resources are not available, it then transmits a message of failure EC of the update of the first slave cluster to the module API 102E which, in turn, transmits it to the module API 102M of the management node 10M of the master cluster during step F10.

In a second embodiment wherein the management node 10E of the first slave cluster has been explicitly authorized to take control of the second slave cluster by the first slave cluster, the database 103E updates its registers with the results of the verification during a step F9′.

During a step F10′, an orchestration loop is implemented by the first slave cluster in order to instantiate a master synchronization module 104M in the management node 10E of the first slave cluster.

Once the orchestration loop has been implemented, the master synchronization module 104M of the management node 10E of the first slave cluster is instantiated and transmits a request for updating the second slave cluster to the module API 102E in a step F11′. The request for updating the second slave cluster D3 includes an update file MaJFC2 of the configuration of the second slave cluster created by the master synchronization module 104M.

In another implementation wherein the management node 10E of the first slave cluster already comprises a master synchronization module 104M, the master synchronization module 104M of the management node 10E transmits, directly after step F7, a request for updating the second slave cluster to the module API 102E in a step F11′.

The module API 102E then transmits, in a step F12′, the configuration update file MaJFC2 of the second slave cluster comprising expected execution conditions of said task by a computing node 11ᵢE of the second slave cluster, the expected execution conditions of the task being identical to the current execution conditions of the same task by the computing node 11ᵢM of the master cluster. The configuration file MaJFC2 is created during step F11′.

A module API 102E of a management node 10E of the second slave cluster receives the configuration update file MaJFC2 and transmits it to a slave synchronization module 104E of the second slave cluster.

The slave synchronization module 104E of the second slave cluster verifies, with at least one computing node 11ᵢE of the second slave cluster, the availability of the resources required for the execution of the task identified in the configuration update file MaJFC2. The slave synchronization module 104E of the second slave cluster transmits the result of this verification to the module API 102E of the second slave cluster. In turn, the module API 102E of the second slave cluster transmits this information to the database 103E of the second slave cluster which updates its registers.

When the slave synchronization module 104E of the second slave cluster has determined that the required resources are available, it transmits a message MC2 confirming the update of the second slave cluster to the module API 102E of the second slave cluster which, in turn, transmits it to the module API 102E of the management node 10E of the first slave cluster during a step F13′.

At the same time, the second slave cluster implements an orchestration loop as described with reference to FIG. 4 in order to configure all of the computing nodes 11,E of the second slave cluster with the execution conditions comprised in the configuration update file MaJFC2.

Upon completion of this step F13′, the second slave cluster is updated and has an operation identical to that of the master cluster.

Finally, in a step F14′, the module API 102E of the management node 10E of the first slave cluster transmits the confirmation message MC2 to the module API 102M of the management node 10M of the master cluster which, in turn, transmits it to the master synchronization module 104M.

Once the update of the second slave cluster has been performed, the first slave cluster recurrently transmits data relating to the execution of the tasks executed by the computing nodes 11,E of the second slave cluster to the master cluster.

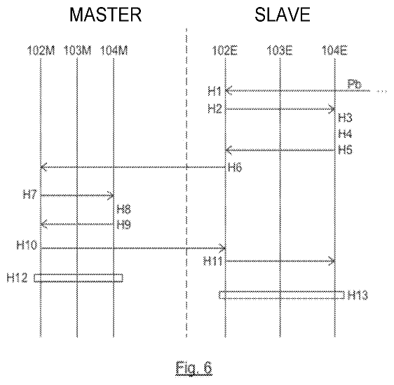

FIG. 6 shows the steps of the control and configuration methods when these are implemented by the different constituents of a master cluster and of a first slave cluster in the case where, the first slave cluster being already controlled by the master cluster, the slave cluster detects an error. Typically, the sequence of steps described with reference to FIG. 6 is located between steps E12 and E13 described with reference to FIG. 3.

In a step H1, the module API 102E of the management node 10E of the first slave cluster receives an error message Pb transmitted for example by a radio antenna of an access node of a communication network, the access node being controlled by the first slave cluster which executes for it network functions such as encoding functions for example.

In a step H2, the module API 102E of the management node 10E transmits the error message Pb to the slave synchronization module 104E of the first slave cluster.

During a step H3, the slave synchronization module 104E verifies the ability of the first slave cluster to solve the error by itself.

If the first slave cluster is able to solve the error by itself, it does so during a step H4.

If the first slave cluster is not able to solve the error by itself, the slave synchronization module 104E transmits this information to the module API 102E in a step H5.

In turn, the module API 102E transmits this information to the module API 102M of the master cluster in a step H6. In turn, the module API 102M of the master cluster transmits this information to the master synchronization module 104M in a step H7.

During a step H8, the master synchronization module 104M determines a solution to solve the error and generates a correction file.

The master synchronization module 104M transmits the correction file to the module API 102M in a step H9.

The module API 102M transmits the correction file to the module API 102E during a step H10.

The slave synchronization module 104E receives, in a step H11, the correction file transmitted thereto by the module API 102E.

During a step H12, an orchestration loop is implemented by the master cluster in order to take account of the information of the correction file during the execution of the tasks by the computing nodes 11ᵢM.

During a step H13, an orchestration loop is implemented by the first master cluster in order to take account of the information of the correction file during the execution of the tasks by the computing nodes 11ᵢE and thus repair the error.

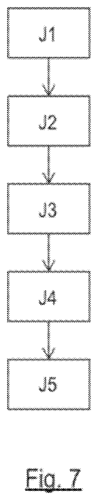

FIG. 7 shows the steps of the control and configuration methods when these are implemented by the different constituents of a master cluster and of a first slave cluster in the case where the messages exchanged between the master cluster and the first slave cluster are relayed by an intermediate piece of equipment.

Thus, when the module API 102M wishes to transmit a first slave cluster Configuration file FC during step E5 or a Configuration update file MaJFC during step F5, the message comprising this configuration or configuration update file is transmitted to an intermediate piece of equipment which then serves as a relay.

In a step J1, the intermediate piece of equipment R receives the message comprising this configuration or configuration update file intended to be relayed to the first slave cluster.

During a step J2, the intermediate piece of equipment R applies security and filtering rules to the message received. For example, such rules are set by the telecommunications operator managing the master cluster and wishing to take control or update the first slave cluster. The intermediate piece of equipment R also verifies whether it is capable of communicating with the first slave cluster.

If the intermediate piece of equipment R determines that the message to be transmitted to the first slave cluster cannot be relayed, it informs the master cluster during a step J3 and indicates the reasons for this refusal.

If the intermediate piece of equipment R determines that the message to be transmitted to the first slave cluster can be relayed, it transmits the message to the first slave cluster during a step J4.

The master cluster is informed of the proper transmission of the message to the first slave cluster when the intermediate piece of equipment transmits thereto, during a step J5, a message confirming the takeover of the first slave cluster or a message confirming the update of the first slave cluster.

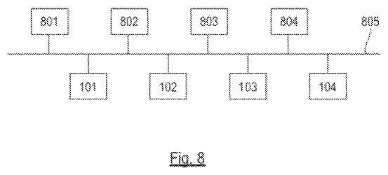

FIG. 8 shows a management node 10 able to implement the different methods objects of the present development.

A management node 10 may comprise at least one hardware processor 801, one storage unit 802, one interface 803, and at least one network interface 804 which are connected together throughout a bus 805 in addition to the module API 102, the controller 101, the database 103 and the synchronization module(s) 104. Of course, the constituent elements of the management node 10 may be connected by means of a connection other than a bus.

The processor 801 controls the operations of the management node 10. The storage unit 802 stores at least one program for the implementation of the different methods objects of the development to be executed by the processor 801, and various data, such as parameters used for computations performed by the processor 801, intermediate data of computations performed by the processor 801, etc. The processor 801 may be formed by any known and suitable hardware or software, or by a combination of hardware and software. For example, the processor 801 may be formed by dedicated hardware such as a processing circuit, or by a programmable processing unit such as a Central Processing Unit which executes a program stored in a memory thereof.

The storage unit 802 may be formed by any suitable means capable of storing the program or programs and data in a computer-readable manner. Examples of storage unit 802 include non-transitory computer-readable storage media such as semiconductor memory devices, and magnetic, optical, or magneto-optical recording media loaded in a read and write unit.

The interface 803 provides an interface between the management node 10 and at least one computing node 11ᵢ belonging to the same cluster of nodes as the management node 10.

In turn, the network interface 804 provides a connection between the management node 10 and another management node of another cluster of nodes.

1. A method for controlling a first cluster of nodes, referred to as a slave cluster, by a second cluster of nodes, referred to as a master cluster, a cluster of nodes comprising at least one computing node executing at least one task, the control method being implemented by the master cluster and comprising:
receiving a request for taking control of the slave cluster identifying at least one task intended to be executed by at least one computing node of the slave cluster,
creating a configuration file of the slave cluster comprising takeover parameters and expected execution conditions of the task by the at least one computing node of the slave cluster, the expected execution conditions of the task being identical to the current execution conditions of the task by at least one computing node of the master cluster,
transmitting the configuration file to the slave cluster, and
receiving a message comprising information relating to the implementation, by the slave cluster, of the required configuration.

2. The method for controlling a slave cluster of nodes according to claim 1, wherein the tasks executed by the master cluster are distributed into a plurality of groups of tasks, a group of tasks comprise at least one task, the configuration file comprises an identifier of at least one group of tasks and the expected execution conditions relating to the group of tasks.

3. The method for controlling a slave cluster of nodes according to claim 1, further comprising:
receiving a request for modifying the configuration of the master cluster comprising expected execution conditions of the task by the at least one computing node of the master cluster,
configuring the master cluster by means of the expected execution conditions, the expected execution conditions becoming, upon completion of the configuration, the new current execution conditions of the task,
creating an update file of the configuration of the slave cluster comprising the expected execution conditions of the task by the at least one computing node of the slave cluster, the expected execution conditions of the task being identical to the new current execution conditions of the task by at least one computing node of the master cluster, and
transmitting the configuration update file to the slave cluster.

4. The method for controlling a slave cluster of nodes according to claim 3, wherein when the update of the configuration of the slave cluster fails, the method further comprises receiving a message indicating the failure of the update of the configuration by the slave cluster.

5. The method for controlling a slave cluster of nodes according to claim 4, further comprising receiving a message comprising information relating to the implementation, by the slave cluster, of the update of the configuration of at least one other slave cluster to which the slave cluster has transmitted a configuration file comprising expected execution conditions of the task by the at least one computing node of the other slave cluster, the expected execution conditions of the task being identical to the current execution conditions of the task by at least one computing node of the master cluster.

6. The method for controlling a slave cluster of nodes according to claim 1, the method comprising receiving a message emitted by an intermediate piece of equipment indicating the impossibility of transmitting a configuration file to the slave cluster.

7. The method for controlling a slave cluster of nodes according to claim 1, comprising:
receiving an error message emitted by the slave cluster,
creating a repair file of the slave cluster comprising repair parameters of the slave cluster, and
transmitting the repair file to the slave cluster.

8. The method for controlling a slave cluster of nodes according to claim 1, comprising:
receiving a liberation request from the slave cluster,
creating a configuration file of the slave cluster comprising liberation parameters of the slave cluster, and
transmitting the configuration file to the slave cluster.

9. A method for configuring a first cluster of nodes, referred to as a slave cluster, by a second cluster of nodes, referred to as a master cluster, a cluster of nodes comprising at least one computing node executing at least one task, the configuration method being implemented by the slave cluster and comprising:
receiving a configuration file of the slave cluster comprising takeover parameters and expected execution conditions of the task by the at least one computing node of the slave cluster, the expected execution conditions of the task being identical to current execution conditions of the task by at least one computing node of the master cluster,
verifying an availability of the resources required for the execution of the task,
when the required resources are available, configuring the slave cluster by means of the configuration file, and
transmitting, to the master cluster, a message comprising information relating to the implementation, by the slave cluster, of the required configuration.

10. The method for configuring a slave cluster of nodes according to claim 9, further comprising:
receiving an update file of the configuration of the slave cluster comprising expected execution conditions of the task by said the at least one computing node of the slave cluster, the expected execution conditions of the task being identical to new current execution conditions of the task by at least one computing node of the master cluster,
verifying an availability of the resources required for the execution of the task,
when the required resources are available, updating the configuration of the slave cluster by means of the configuration update file, and
transmitting, to the master cluster, a message comprising information relating to the implementation, by the slave cluster, of the required configuration.

11. The method for configuring a slave cluster of nodes according to claim 10, wherein when the required resources are not available, the method further comprises emitting a message indicating the failure of the update of the configuration to the master cluster.

12. The method for configuring a slave cluster of nodes according to claim 11, further comprising when the required resources are not available:
transmitting a configuration file comprising expected execution conditions of the task by at least one computing node of another slave cluster, the expected execution conditions of the task being identical to the current execution conditions of the task by at least one computing node of the master cluster,
receiving a message comprising information relating to the implementation, by the other slave cluster, of the required configuration, and
transmitting, to the master cluster, a message comprising information relating to the implementation, by the other slave cluster, of the required configuration.

13. A management node of a first cluster of nodes, referred to as a master cluster, capable of controlling a second cluster of nodes, referred to as a slave cluster, a cluster of nodes also comprising at least one computing node executing at least one task, the management node of the master cluster comprising means to:
receive a request for taking control of the slave cluster identifying at least one task intended to be executed by at least one computing node of the slave cluster,
create a configuration file of the slave cluster comprising takeover parameters and expected execution conditions of the task by the at least one computing node of the slave cluster, the expected execution conditions of the task being identical to the current execution conditions of the task by at least one computing node of the master cluster,
transmit the configuration file to the slave cluster, and
receive a message comprising information relating to the implementation, by the slave cluster, of the required configuration.

14. A management node of a first cluster of nodes, referred to as a slave cluster, capable of configuring the slave cluster, a cluster of nodes also comprising at least one computing node executing at least one task, the slave cluster management node comprising means to:
receive, from a second cluster of nodes, referred to as a master cluster, a configuration file of the slave cluster comprising takeover parameters and expected execution conditions of the task by the at least one computing node of the slave cluster, the expected execution conditions of the task being identical to current execution conditions of the task by at least one computing node of the master cluster,
verify an availability of the resources required for the execution of the task,
when the required resources are available, configure the slave cluster by means of the configuration file, and
transmit, to the master cluster, a message comprising information relating to the implementation, by the slave cluster, of the required configuration.

15. A processing circuit comprising a processor and a memory, the memory storing program code instructions of a computer program for implementing the method according to claim 1, when the computer program is executed by the processor.
